(19) United States
(12) Patent Application Publication
(10) Pub. No.: US 2026/0267619 A1
(43) Pub. Date: Sep. 10, 2026

(54) DETECTING DUPLICATIVE COMPUTER CODE VIA MACHINE LEARNING

(71) Applicant: PAYPAL, INC., San Jose, CA (US)

(72) Inventor: Sriram Srinivasan, Chennai (IN)

(21) Appl. No.: 19/069,737

(22) Filed: Mar. 4, 2025

(51) Int. Cl. G06F 8/35

(52) U.S. Cl. CPC G06F 8/35

(57) ABSTRACT

A determination is mad that computer software code corresponding to one or more particular levels of hierarchy of a work structure of an entity has been created or modified. One or more work data fields associated with the computer software code are accessed. A first document embedding is generated based on the one or more work data fields. The first document embedding comprises multi-dimensional vectors that represent a semantic content of the first document embedding. A similarity check is performed between the first document embedding and one or more other document embeddings. An action is performed based on a determination that the similarity check indicates that a similarity between the first document embedding and the one or more other document embeddings meets a specified threshold.

### BACKGROUND

### Field of the Invention

The present application generally relates to machine learning. More particularly, the present application involves using machine learning to detect potentially duplicative computer code according to various embodiments.

### Related Art

Rapid advances have been made in the past several decades in the fields of computer technology and telecommunications. These advances have led to more and more operations being conducted electronically, which require implementation via computer software code. Often times, within an organization (e.g., a company that develops software), there may be multiple teams of software developers that work on projects that are similar in nature. However, due at least in part to a lack of communication among the team members, each team may not be aware of the fact (or the extent) that one or more other teams may be working on a similar project. This problem is exacerbated as the size of the organization increases and/or the confidentiality or secrecy of the projects are maintained even within an organization. As a result, different teams within an organization may develop computer software code that is at least partially duplicative of computer software code developed by other teams within the organization for a similar project, which is a waste of computer resources. What is needed is a system and method to automatically detect duplicative computer software code and to generate notifications for the appropriate personnel, so that organizations may avoid waste and better utilize their resources.

### BRIEF DESCRIPTION OF THE FIGURES

FIG. 1 is a block diagram of an example environment in which computer software code can be generated according to various aspects of the present disclosure.

FIG. 2 is a block diagram of an example hierarchical work structure according to various aspects of the present disclosure.

FIG. 3 is a flow chart for determining duplicacy according to various aspects of the present disclosure.

FIG. 4 is a block diagram of a process flow for checking for similarities between different works according to various aspects of the present disclosure.

FIG. 5 is an example computer system according to various aspects of the present disclosure.

FIG. 6 illustrates an example system involving neural networks according to various aspects of the present disclosure.

FIG. 7 is a simplified example of a cloud-based computing architecture according to various aspects of the present disclosure.

FIG. 8 is a flow chart for performing a method according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

In recent years, machine learning has become a useful tool to identify patterns and/or trends and make predictions. However, machine learning has not been sufficiently deployed to detect potentially duplicative computer software code within an organization. In that regard, within an organization, there may be multiple teams dedicated to developing computer software code for different projects. However, some of these projects may have overlapping scope, such that their corresponding computer software code (or at least portions thereof) may be substantially duplicative of one another, which is a waste of not only human capital, but electronic resources as well. For example, electronic memory (e.g., Random Access Memory (RAM) or the non-volatile memory of a hard drive) may be wasted in electronically storing the duplicative computer software code, computer processing power (e.g., Central Processing Unit (CPU) or Graphics Processing Unit (GPU)) may be wasted in compiling and/or executing the duplicative computer software code, and telecommunication bandwidth (e.g., over an intranet or the Internet, via mechanisms such as Ethernet, modems, fiber optic cables, or satellite communications) may be wasted in transmitting and/or receiving the duplicative computer software code among various entities within the organization. Such forms of waste may slow down software development and/or increase the cost of the software development within the organization.

To address these issues discussed above, the present disclosure utilizes machine learning to detect potentially duplicative computer software code as the code is being created and/or modified. In one embodiment, the present disclosure uses various machine learning techniques to convert textual data associated with the computer software code of a particular work project to a standard format file that includes multi-dimensional vectors that represent the lexical or semantic content of the computer software code. Various machine learning techniques are then used to compare the file with other files that have also been converted based on the computer software code of other work projects. Based on the comparison, a degree of similarity (e.g., a similarity score) is determined between these files. If the degree of similarity is sufficiently high (e.g., meeting a specified threshold), then the computer software code is deemed potentially duplicative of the computer software code of the other work projects. Appropriate personnel within the organization are then notified, and the corresponding actions may be taken to address the potential duplication, such as by terminating the duplicative work project to avoid wasting further resources on its development.

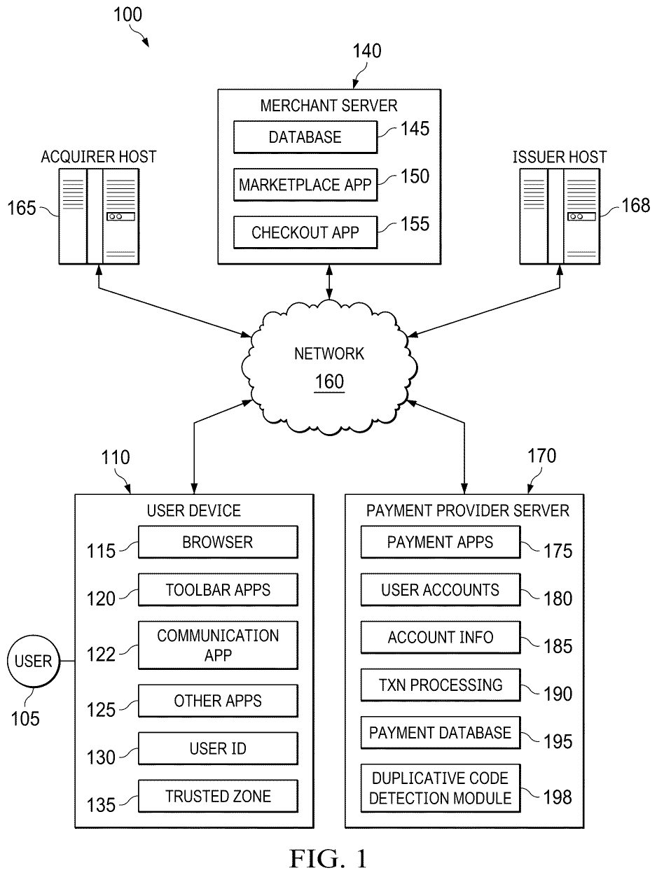

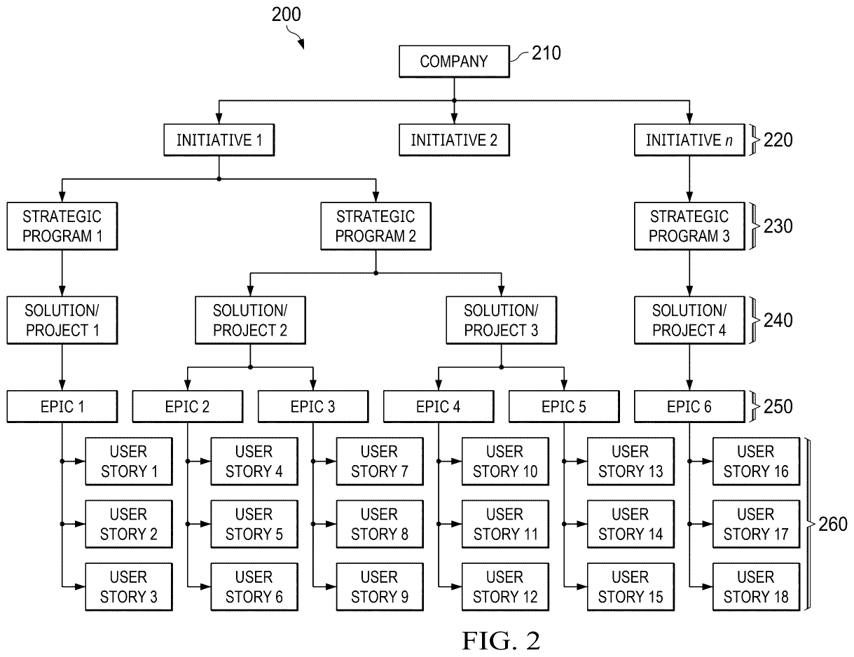

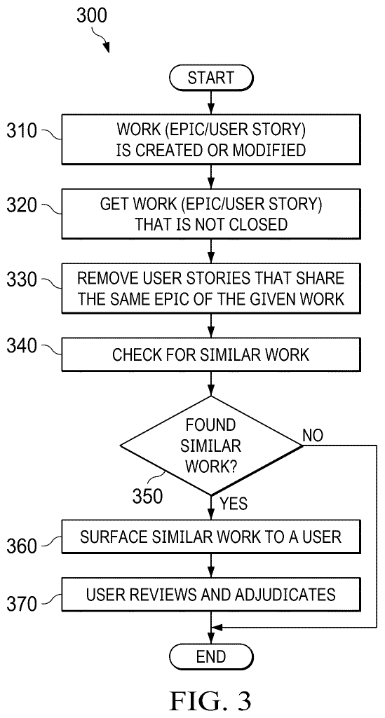

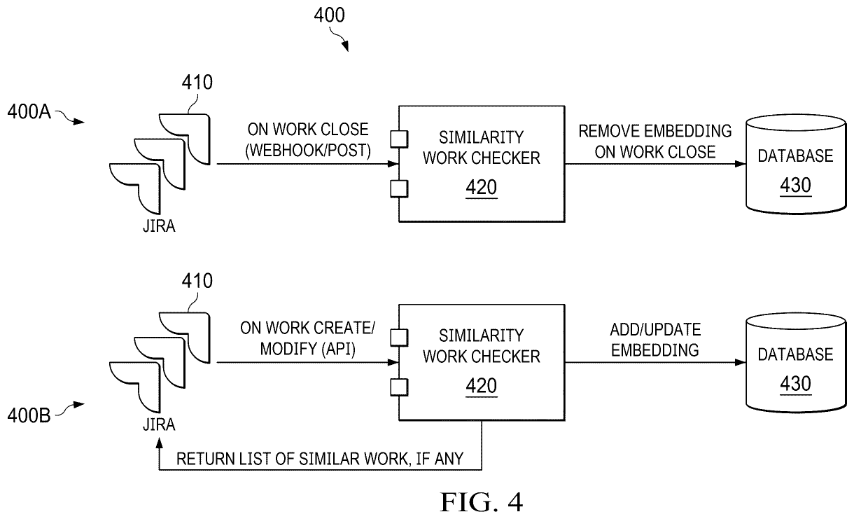

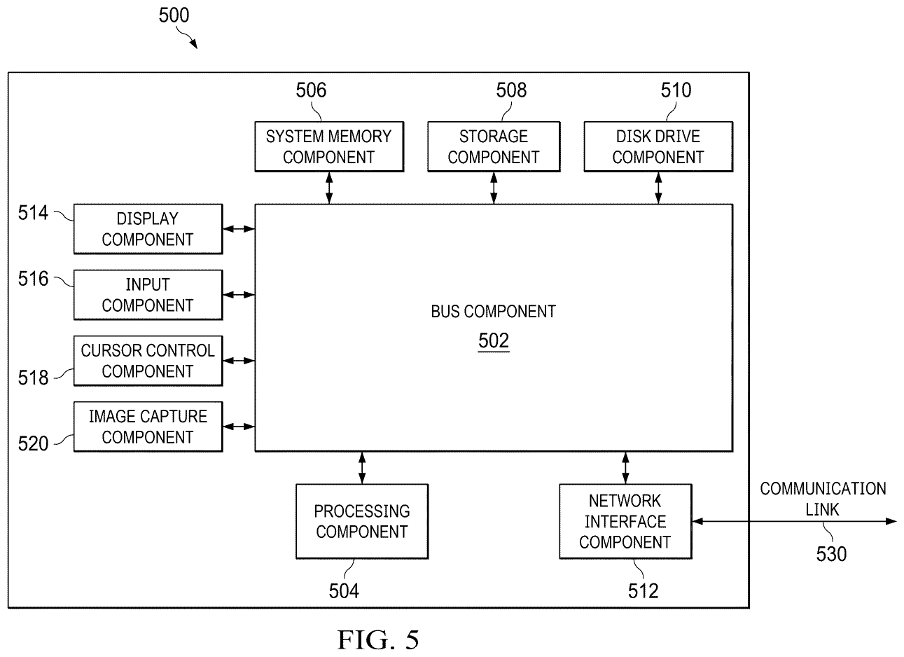

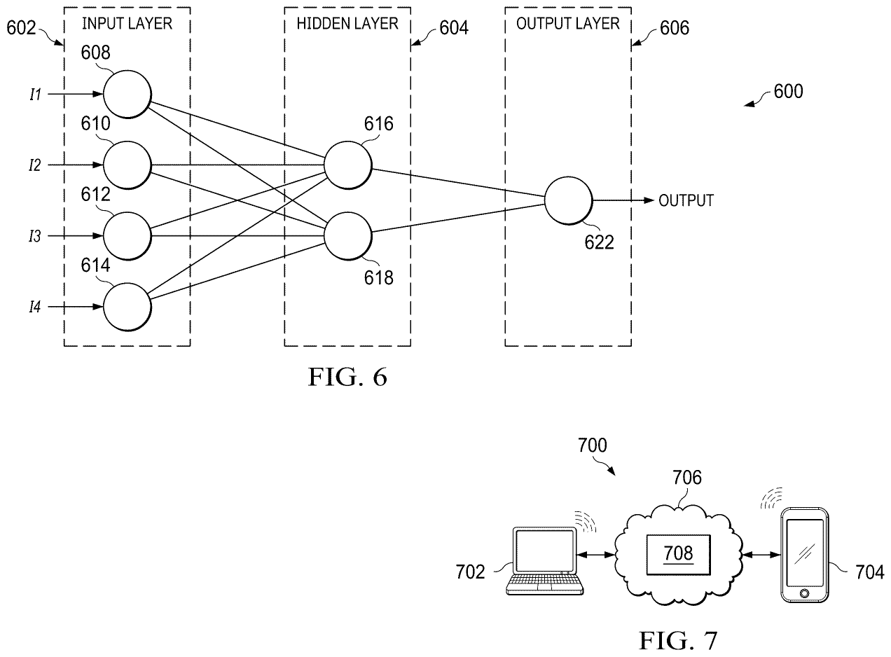

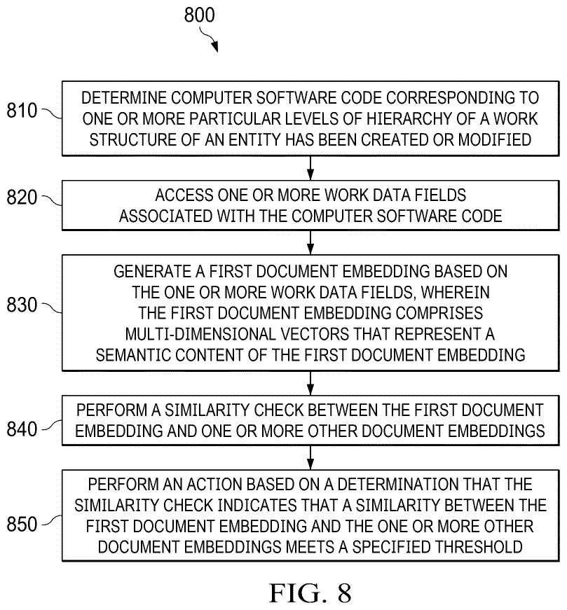

The various aspects of the present disclosure are discussed in more detail with reference to FIGS. 1-8. In more detail, FIG. 1 illustrates an example context in which computer software code may be generated according to embodiments of the present disclosure. FIG. 2 is a block diagram of an example hierarchical work structure according to embodiments of the present disclosure. FIG. 3 illustrates a flow chart for determining duplicacy according to embodiments of the present disclosure. FIG. 4 is a block diagram of a process flow for checking for similarities between different works according to embodiments of the present disclosure. FIG. 5 illustrates an example computer system for performing in various methods of the present disclosure. FIG. 6 illustrates an example machine learning architecture according to embodiments of the present disclosure. FIG. 7 illustrates an example cloud computing architecture according to embodiments of the present disclosure. FIG. 8 is a flow chart for performing a method according to various aspects of the present disclosure.

Referring now to FIG. 1, a block diagram of a networked system 100 is illustrated. The networked system 100 corresponds to an environment that is suitable for conducting electronic online transactions, where computer software code may be generated to facilitate the various aspects of the online transactions. Networked system 100 may comprise or implement a plurality of servers and/or software components that operate to perform various payment transactions or processes. Exemplary servers may include, for example, stand-alone and enterprise-class servers operating a server OS such as a MICROSOFT™ OS, a UNIX™ OS, a LINUX™ OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Networked system 100 may include a user device 110, a merchant server 140, a payment provider server 170, an acquirer host 165, and an issuer host 168 that are in communication with one another over a network 160. Payment provider server 170 may be maintained by a payment service provider, such as PayPal™, Inc. of San Jose, CA. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. User 105 may also be an employee of or person working with an entity or company associated with merchant server 140 or payment provider server 170, such that user 105 may use user device 110 to view output from merchant server 140 or payment provider server 170 related to identification of duplicative software code. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, payment provider server 170, acquirer host 165, and issuer host 168 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the payment provider or view output from payment provider server 170 associated with identification of duplicative software code as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100. User device 110 may also include other applications 125, for example the mobile applications that are downloadable from the Appstore™ of APPLE™ or GooglePlay™ of GOOGLE™.

In conjunction with user identifiers 130, user device 110 may also include a secure or trusted zone 135 owned or provisioned by the payment service provider with agreement from device manufacturer. The secure zone 135 may also be part of a telecommunications provider SIM that is used to store appropriate software by the payment service provider capable of generating secure industry standard payment credentials or other data that may warrant a more secure or separate storage, including various data as described herein.

Still referring to FIG. 1, merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145. In some embodiments, the merchant server 140 may also host a website for an online marketplace, where sellers and buyers may engage in purchasing transactions with each other.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, as described herein. As such, transaction processing application 190 may store details of an order from individual users, including funding source used, credit options available, etc. Payment application 175 may be further configured to determine the existence of and to manage accounts for user 105, as well as create new accounts if necessary.

According to various aspects of the present disclosure, a duplicative code detection module 198 may also be implemented on, or accessible by, the payment provider server 170. The duplicative code detection module 198 may include one or more software applications or software programs that can be automatically executed (e.g., without needing explicit instructions from a human user) to perform certain tasks. For example, one or more of the entities, such as a company operating the payment provider server 170 or a company operating the merchant server 140, may generate computer software code to implement various functionalities, which may facilitate electronic transactions with the user 105, as a simple example. Within any given company, the computer software code may be generated by multiple teams of software developers, who may be working on projects with overlapping scopes but may not be aware of this fact. As a result, often times the multiple teams of software developers may end up writing computer software code that may be substantially (or at least partially) duplicative of other computer software code that has already been written by different teams, which as discussed above, may lead to waste of electronic resources such as computer processor power, electronic memory storage space, and/or network bandwidth.

The present disclosure implements the duplicative code detection module 198 to perform machine learning processes to timely detect and identify the potentially duplicative computer software code. The duplicative code detection module 198 may also automatically notify the appropriate personnel within the company, such as to user 105 through user device 110, so that suitable actions may be taken to reduce the waste of electronic resources, such as by terminating work projects that may truly duplicative of other work projects. Since the duplicative code detection module 198 can detect these potentially duplicative work projects at an early stage, it not only frees up the computer processing and/or electronic storage resources, but also reduces unnecessary network traffic (that would otherwise be occupied to transmit and/or receive the computer software code associated with the work projects within a company), thereby freeing up network communication bandwidth. As such, the duplicative code detection module 198 transforms a generic computer into a special machine capable of performing a specific predefined task: identifying duplicative computer software code and preventing further electronic resources from being wasted on the further development of work projects associated that led to the generation of the duplicative computer software code. Accordingly, the present disclosure offers an improvement in computer technology. The details regarding the duplicative code detection module 198 will be discussed in more detail below with reference to FIGS. 3-4.

It is noted that although the duplicative code detection module 198 is illustrated as being separate from the transaction processing application 190 in the embodiment shown in FIG. 1, the transaction processing application 190 may implement some, or all, of the functionalities of the duplicative code detection module 198 in other embodiments. In other words, the duplicative code detection module 198 may be integrated within the transaction processing application 190 in some embodiments. In addition, it is understood that the duplicative code detection module 198 (or another similar program) may be implemented on the merchant server 140, on a server of any other entity operating a social interaction platform, or even on a portable electronic device similar to the user device 110 (but may belong to an entity operating the payment provider server 170) as well. It is also understood that the duplicative code detection module 198 may include one or more sub-modules that are configured to perform specific tasks. For example, the duplicative code detection module 198 may include a first sub-module configured to train the machine learning model, as well as a second sub-module configured to make predictions based on the trained model.

Still referring to FIG. 1, a payment network may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. The payment network interfaces with the acquirer host 165, the issuer host 168, and/or the payment provider 170 server to facilitate transactions, according to various embodiments. For example, the payment provider server 170 may forward a transaction request to the payment network. The payment network may assess the transaction and may then send it to the acquirer host 165 or the issuer host 168 as a part of processing the transaction request. A network of communication devices, servers, and the like also may be established to relay payment related information among the different parties of a payment transaction.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at or with various merchants who agreed to accept the payment card.

Referring now to FIG. 2, a block diagram of an example work structure 200 of an example organization is illustrated. In some embodiments, the organization may be the entity that operates the payment provider 170, the entity that operates the merchant server 140, the acquirer host 165, or the issuer host 168 discussed above with reference to FIG. 1. In other embodiments, the organization may include private companies or public institutions, such as an operator of an electronic transaction platform, a software code sharing or management platform, a cybersecurity platform, a healthcare organization, a school (e.g., a university), a financial institution, a business analyst, a partnership, a charitable foundation, a religious institution, a social club, a professional association, etc.

The work structure 200 includes a plurality of levels 210-260 of a hierarchy. The work associated with each level of the hierarchy may be implemented by one or more software development teams using a specified software development methodology, such as the Agile methodology, which may break the overall project into different phases (e.g., also referred to as sprints). In some embodiments, the work may include, or may be implemented via, various types of computer software code. In the context of the present disclosure, computer software code may include not just the actual programming code written in a particular computer programming language (e.g., C++, Java, or Python), but it may also include the corresponding textual descriptions, such as comments added by a programmer to explain the purpose of a section of computer programming code, a title of a file, a summary of a project, etc. In any case, based on an overall goal of the organization, the work associated with each level of the hierarchy is cascaded down to each lower level, and the corresponding work (e.g., the computer software code generated by the software development teams) may be captured via various tools.

In the embodiment illustrated in FIG. 2, a highest level 210 of the hierarchy of the work structure 200 may include a company as a form of the organization. In some embodiments, the company may be engaged in various types of software development. In addition, the company may be engaged in endeavors other than software development in some embodiments. For example, the company may also manufacture hardware and/or firmware in addition to developing software. Of course, it is understood that the manufacturing of hardware or the development of firmware may also at least partially involve software development in some cases.

The level 220 of the hierarchy is located one level below the highest level 210 in the work structure 200. In the illustrated embodiment of FIG. 2, the level 220 of the hierarchy includes a plurality of initiatives, such as initiative 1, initiative 2, up to initiative n, where n is 3 in this example, but can be any suitable number for the company. In some embodiments, initiatives may include collections of strategic programs that drive toward a common goal. For example, a goal to improve a reliability of a product or a service may be a form of an initiative. Various types of tools, such as computer software applications or platforms, may be used to implement the initiatives 1-3. In some embodiments, the initiatives 1-3 may be implemented at least in part using a project management software tool, such as CLARIZEN™ by PLANVIEW™, or using a cloud computing platform, such as the NOW PLATFORM™ by SERVICENOW™.

The level 230 of the hierarchy is located one level below the level 220 in the work structure 200. In the illustrated embodiment of FIG. 2, the level 230 of the hierarchy includes a plurality of strategic programs. Each of the initiatives 1-3 may include one or more corresponding strategic programs. For example, the initiative 1 may include a strategic program 1 and a strategic program 2, and the initiative n(3) may include a strategic program 3. A strategic program may be a program that helps to achieve one or more goals defined by the initiative. For example, an AI-driven incident management may be a form of the strategic program. The strategic programs may also be implemented using a computer software application, such as CLARIZEN™ by PLANVIEW™, or a cloud platform, such as NOW PLATFORM™ by SERVICENOW™.

The level 240 of the hierarchy is located one level below the level 230 in the work structure 200. In the illustrated embodiment of FIG. 2, the level 240 of the hierarchy includes a plurality of solutions or projects. Each of the strategic programs 1-3 may include one or more corresponding solutions or projects. For example, the strategic program 1 may include a solution/project 1, and the strategic program n(3) may include a solution/project 4, but the strategic program 2 may include two solutions/projects, a solution/project 2 and a solution/project 3. A solution/project may include a specific software solution or a software project that helps to implement one or more aspects of the corresponding strategic program. For example, an incident management AI copilot may be a form of the solution/project. The solution/project may also be implemented using a computer software application, such as CLARIZEN™ by PLANVIEW™, or a cloud platform, such as NOW PLATFORM™ by SERVICENOW™, or a project management or tracking tool, such as JIRA™ by ATLASSIAN™.

The level 250 of the hierarchy is located one level below the level 240 in the work structure 200. In the illustrated embodiment of FIG. 2, the level 250 of the hierarchy includes a plurality of epics. Each of the solutions/projects 1-4 may include one or more corresponding epics. For example, the solution/project 1 may include an epic 1, and the solution/project 4 may include an epic 6, but the solution/projects 2 and 3 may include two epics, an epic 2 and 3 and an epic 4 and 5, respectively. An epic may be a body of work that can be broken down into a plurality of smaller tasks, such as user stories (discussed in more detail below). For example, an impact assessment data in an incident channel may be a form of the epic. The epic may also be implemented using a project management or tracking tool, such as JIRA™ by ATLASSIAN™.

The level 260 of the hierarchy is located one level below the level 250 in the work structure 200. In the illustrated embodiment of FIG. 2, the level 260 of the hierarchy includes a plurality of user stories. Each of the epics 1-6 may include one or more corresponding user stories. For example, the epic 1 may include user stories 1-3, and the epic 2 may include user stories 4-6. A user story may be a short requirement or a request written from the perspective of an end user that is completed in one sprint (which may typically last about one or several weeks). For example, an impact assessment tool integration with a specified platform may be a form of the user story. The user story may also be implemented using a project management or tracking tool, such as JIRA™ by ATLASSIAN™.

Most, if not all, of the software development work for any given embodiment of the work structure 200 is captured (e.g., by tools/platforms such as JIRA™, CLARIZEN™, or SERVICENOW™) under the epics corresponding to level 250 of the hierarchy and/or the user stories corresponding to level 260 of the hierarchy. The computer software code associated with the epics and user stories are used in a Software Capitalization Accounting process, and thus it may be included in a Cap Credit reporting, which improves an ability of any given organization to track end-to-end engineering efforts and increases an overall Book of Work (BoW) transparency for management of the work done within the organization. Since the computer software code associated with the epics and/or user stories is typically readily available within any organization, it may be subjected to real-time AI analysis (e.g., via machine learning) to identify and/or minimize the duplicative efforts across the various computer software development teams within the organization, according to various aspects of the present disclosure discussed below.

FIG. 3 is a flowchart illustrating a process flow 300 according to various aspects of the present disclosure. Some of the steps of the process flow 300 may be performed at least in part using the duplicative code detection module 198 of FIG. 1.

The process flow 300 includes a step 310, in which work is created or modified. The work may include computer software code corresponding to an epic or a user story discussed above in association with FIG. 2. As discussed above, the computer software code may be generated by various software development teams within a given organization, and some of the code may be duplicative of other code, due at least in part to the similarities in the type of work being performed by the different software development teams. In order to minimize the amount of software code duplication, the contents of the work should be checked for duplicacy/similarity.

In the illustrated embodiment, the process flow 300 proceeds to a step 320 to access work (e.g., epic or user story) that is not closed (e.g., finished or completed). In more detail, one objective of the present disclosure is to check for duplicate or similar work (e.g., coding the epics or user stories) as the work that is currently being done, or at least when the entire project has not been completed. Otherwise, it would be too late to do anything about duplicative computer code associated with different epics or user stories in the past, as the duplication (and thus the waste in computer and/or human resources) had already occurred. Therefore, step 320 of the process flow 300 need not access computer software code associated with historical work. Instead, step 320 merely needs to access computer software code associated with work (e.g., epic or user story) that has not been closed. In this manner, whatever computer software code that is deemed to be duplicative of other computer software code is necessarily associated with a recent epic or user story, and therefore remedial steps can be taken to prevent further resources from being expended to complete such an epic or user story. In some embodiments, the work that is not closed may be in one of the following states: Backlog, Defined, Blocked, In Progress, Ready For Review, In Review, Ready for Testing, In Testing, or Completed. In obtaining only work that has not been closed (and later checking for duplication within such work), the present disclosure can ensure that the computer resources (e.g., computer processing power, electronic memory, and/or network bandwidth) are spent in a targeted manner, and therefore an accurate result may be obtained more efficiently.

It is understood, however, that other embodiments of the process flow 300 may access computer software code associated with historical work (e.g., work that has already been closed) that meets one or more specified criteria, in addition to the computer software code that has not been closed. For example, in some embodiments, work that was closed within the past week, or past month, may also be obtained by step 320. This may be situationally suitable when it is still beneficial to identify (and possible remove) the recently created duplicative code even if it is already closed, for example, to free up additional electronic storage space, or to investigate what could have led to the generation of the duplicative code. As another example, work that was done by a specified software development team (even if it was already closed) may also be obtained by step 320. This may be situationally suitable when the specified software development team has had a history of generating duplicative code. As yet another example, work that was done for a specified epic or user story (even if it was already closed) may also be obtained by step 320. This may be situationally suitable when the specified epic or user story is known to have a greater likelihood of generating duplicative code.

The process flow 300 proceeds to a step 330 to remove user stories that share the same epic of a given work. This is because for a given epic, there may be multiple user stories that share similarities in their corresponding computer software code. This is not surprising, since the user stories are implemented to achieve the same goal of implementing that given epic. To the extent that the different user stories are developed by different teams of developers, these teams of developers may already be aware of what the other teams are doing. In that manner, whatever computer software code that may on the surface appear to be duplicative of other code may actually not be duplicative at all, but instead may be needed to serve its unique function. Therefore, for any given user story of a specified epic, the step 330 may remove the other user stories originating from the same epic from consideration (e.g., in terms of checking for duplication). However, the epics still need to be checked for duplicacy or similarity, even if multiple epics share the same solution project. This is because at the hierarchy level of the epic, the similarities in computer software code may truly be an indication of multiple software development teams unknowingly duplicating their development efforts, rather than them collaborating on the same project.

The process flow 300 proceeds to a step 340 to check for similar work. In the illustrated embodiment, such a similarity check of step 340 is done to the work that is not closed and after the user stories that share the same epic has been removed. In some embodiments, the step 340 may check the similarity in the computer software code for various epics and/or user stories by comparing the textual content of the computer software code. In some embodiments, such a text similarity check can be implemented using a lexical-based approach of machine learning, which may include techniques such as cosine similarity or Jaccard similarity. In some other embodiments, such a text similarity check can be implemented using a semantic-based approach of machine learning, which may include techniques such as word embeddings, sentence embeddings, document embeddings, or semantic similarity measures. In some embodiments, such a text similarity check can also be implemented using a hybrid approach of machine learning, which may include using machine learning models to learn complex patterns in the text and predict similarity scores. Each of the above approaches has its own strengths and weaknesses, and thus the choice for the approach depends on the specific requirements and the nature of the text being analyzed. As non-limiting examples, the following steps may be performed:
Preprocessing: Clean the text by tokenization, lowercasing, removing stop words, and stemming/lemmatization.
Normalization: Normalize the features (e.g., TF-IDF weights) to ensure consistency.
Evaluation: Use appropriate evaluation metrics (e.g., F1-score, Precision, Recall, etc.) to assess the performance.

In some embodiments, to enhance the checking of similarity between different works, the format of the work data associated with the epics and/or user stories may be standardized, for example, by introducing one or more mandatory fields in the work data. Some non-limiting examples of such mandatory fields may include:
Summary or title: a summary or a title of the epic or user story.
Description: a description of the epic or user story, such as how the epic or user story will be implemented.
Outcome: an expected outcome or an actual outcome of the epic or user story.
Metrics: one or more acceptance criteria of the epic or user story, or a definition of a performance indicator (KPI).

The process flow 300 proceeds to a decision step 350 to determine whether similar work was found. In other words, based on the results from step 340, the decision step 350 may determine whether the computer software code of a particular epic or user story is sufficiently similar to the computer software code of any other epic or user story. In some embodiments, the degree of similarity may be evaluated based on a specified threshold, such as a specified similarity score. If the answer from the decision step 350 is a “no”, then the process flow 300 may end. On the other hand, if the answer from the decision step 350 is a “yes”, then the process flow 300 may proceed to the step 360.

In step 360 of the process flow 300, similar work is surfaced to a user. Note that the similar work may include more than one epic or more than one user story. For example, the decision step 350 may determine that two epics or three user stories contain computer software code that is deemed to be sufficiently similar (e.g., meeting a specified similarity score threshold) to the computer software code from other epics and/or other user stories. The step 360 then surfaces these epics and/or user stories to an appropriate user. In some embodiments, the user may include personnel that created or modified the epic and/or user story in question, for example, the human programmer who coded the epic and/or user story. In other embodiments, the user may include a person with managerial duties and/or who is otherwise responsible for overseeing the development of one or more user stories, epics, or higher levels of hierarchy in the work structure 200.

Regardless of the type of role the user may serve within the organization, the process flow 300 may proceed to a step 370, in which the user review the epic or user story in question for similarity and possible collaboration. Based on the review, the user may either close the epic or user story, for example, if the user determines that the epic/user story is indeed too similar to another epic/user story. Alternatively, the user may continue to work on the epic or user story (or instruct other personnel who is directly responsible for coding the epic or user story to do so), for example, if the user determines that the epic/user story is not too similar to any other epic/user story. In situations when the similarity score meets an even higher threshold (e.g., above 80% match), the state of the work may be subjected to an additional review, for example, by a different person (e.g., someone even higher up in the hierarchy). The additional review would involve reviewing the other similar works and/or registering their comments along with their decision. In any case, after the potentially similar work has been sufficiently reviewed by one or more appropriate entities, the backend records in a databases may be updated, for example, by including a list of work that may be considered to be potentially too similar to other works. At regular intervals, such as on a weekly or monthly basis, a report may be automatically generated that includes the epics and/or user stories that were created or modified that were deemed to have sufficient similarity with existing epics and/or user stories. Such a report may also be sent to an appropriate entity on the hierarchy for review and/or adjudication. The process flow 300 may then end after the step 370 is completed.

FIG. 4 is a block diagram of a process flow 400 for checking for similarities between the computer software code of different epics and/or user stories and taking corresponding actions thereafter according to an embodiment of the present disclosure. In other words, the process flow 400 corresponds to various steps of the process flow 300, such as steps 340-360 of the process flow 300. As such, the process flow 400 may also be performed at least in part using the duplicative code detection module 198 of FIG. 1. As will be discussed in more detail below, a document embedding technique—as an example of the semantic-based approach—may be used to implement various aspects of the process flow 400 (e.g., checking for similarities between the computer software code of different works).

As shown in FIG. 4, the process flow 400 may be implemented at least in part using a similarity work checker component 420 and a database component 430. In some embodiments, the duplicative code detection module 198 may include the similarity work checker component 420 and the database component 430. In some embodiments, the database component 430 may be implemented separately from the duplicative code detection module 198. For example, the database component 430 may be a part of the payment database 195 of FIG. 1, or another database that is external to the payment provider server 170. In some embodiments, the similarity work checker component 420 may include one or more application programming interfaces (APIs) that are specifically configured to interact with various software tools or platforms, such as for JIRA™.

In some embodiments, the database component 430 may include a database to hold the computer software code and/or other types of data associated with the epic or user story being checked. For example, data such as document embedding data may be generated from the epic or user story and stored in the database component 430. In some embodiments, the data (e.g., document embedding data) may be from epics or user stories that have already been closed (e.g., not being actively worked on).

For example, in a first portion 400A of the process flow 400, work data (e.g., computer software code corresponding to an epic or a user story) that has been closed may be captured by a work management tool 410 (such as JIRA™). The work management tool may send the work data to the similarity work checker component 420, for example, via a webhook (e.g., an automated message that sends data between applications when a specific event occurs) or a post. As discussed above, the work details captured may include computer programming code, and/or textual data associated with the computer programming code, including but not limited to the ID of an epic or user story, title of the epic or user story, a description of the epic or user story, a summary of the epic or user story, an expected or actual outcome of the epic or user story, and/or a metric of the epic or user story. It is understood that some of the work details may be captured from mandatory data fields included in the epic or user story.

The similarity work checker 420 may then perform a preprocessing step to clean up the work details received from the work management tool 410. In some embodiments, the preprocessing step may include performing a tokenization process to the work details. For example, the tokenization process may break down the text corresponding to the work details into a plurality of smaller pieces, where each of the smaller pieces may be considered a token. The smaller pieces may be words or partial words in some embodiments, or phrases in some other embodiments, or characters in yet other embodiments. Once broken down into tokens, the work details may be easier to analyze via machine learning.

In some embodiments, the preprocessing step may include performing a lowercasing process to the work details. The lowercasing process may convert upper-case letters in the work details into their corresponding lower-case letters. For example, an upper-case letter “A” may be converted into a lower-case letter “a” by the lowercasing process. Lowercasing the work details may improve the uniformity of the work details, which may improve the efficiency and/or speed of any subsequently performed machine learning process.

In some embodiments, the preprocessing step may include removing stop words from the work details. In that regard, stop words include a set of words in a given language, where the words are commonly used in that language but do not provide much meaning. In the case of the English language, stop words may include determiners, coordinating conjunctions, and prepositions. Determiners typically mark nouns where a determiner is followed by a noun. For example, determiners may include words like “the”, “a”, “an”, “another”, etc. Coordinating conjunctions may include words that connect words, phrases, and clauses. For example, coordinating conjunctions may include words like “and”, “for”, “nor”, “or”, “but”, “yet”, “so”, etc. Prepositions may include words that express temporal or spatial relations. For example, prepositions may include “in”, “of”, “over”, “under”, “from”, “into”, “during”, “upon”, “towards”, etc. The removal of the stop words from the work details analysis allows any subsequently performed machine learning analysis to focus on more important words instead. As such, it may improve the accuracy of the machine learning analysis. In addition, the removal of the stop words from the work details also reduces the amount of computer processing power and/or memory storage (e.g., the processors and/or memory of the duplicative code detection module 198) needed to perform the analysis. Therefore, the removal of the stop words may also improve the speed and efficiency of the machine learning analysis.

In some embodiments, the preprocessing step may include performing a stemming process or a lemmatization process to the work details. In that regard, the stemming process may use a set of predefined rules to remove certain characters from a word, such as suffixes (e.g., “-ed” or “-ing”), which may reduce the word to its base form, even if the base form of the word may not be a real word. In comparison, the lemmatization process may consider the context in which a word is used and may convert the word to its meaningful base form (e.g., also referred to as a lemma). For instance, lemmatizing the word “caring” would return “care”, whereas stemming the word “caring” would have returned “car.” Stemming and lemmatization each have their advantages and drawbacks. For example, stemming may be performed at a faster speed than lemmatization, but lemmatization is more accurate than stemming. As such, stemming may be more suitable in situations where a large dataset needs to be preprocessed quickly, while lemmatization may be more suitable in situations where precision and meaningfulness of the words are more important considerations than the speed of processing.

In some embodiments, the preprocessing step may include performing a key phrase extraction process to the work details. In particular, key phrase extraction may use machine learning and natural language processing (NLP) to identify the main points in a text document. NLP may involve the use of statistical methods and neural networks to analyze patterns in human language. Key phrase extraction may use such NLP analysis to return key phrases, confidence scores, and/or subjects/objects being discussed in a particular document. As such, key phrase extraction may be used to quickly extract and/or identify important points or the main topics from unstructured text.

After the work details (e.g., captured from epics and/or user stories) have been preprocessed, document embeddings may be generated by the similarity work checker component 420, for example via one or more machine learning techniques. First, the entirety of the preprocessed work details (e.g., in textual format) may be considered as a single document. The document is then converted into fixed-length vector embeddings. Various techniques may be used to generate embeddings, which include multi-dimensional vectors representing the semantic content of the document. In some embodiments, natural language processing (NLP) may be used as a machine learning technique to generate the embedding.

One example NLP technique is word2vec, which may use a neural net to process textual data by vectorizing words. For example, an input of a word2vec process may be a body of text (e.g., the textual data extracted from the work ID, work title, and/or work description of the epics and/or user stories that were recently created or modified), and an output of the word2vec process may be a set of vectors, for example feature vectors that represent words in that body of text. Each word in the textual data may have a corresponding vector, and the entirety of the textual data of that user may be represented as a vector-space. Word2vec may be useful because it can group the vector representations of similar words together in a vector-space, for example, the words “dog” and “cat” may be closer together in vector-space than the words “dog” and “aspirin”. This may be done by detecting their similarities mathematically, since mathematical operations may be performed on or using vectors. In this manner, word2vec allows mathematical processing (which is very convenient for computers) on human language data, which may make word2vec well-suited for machine learning. In a simplified example, via the application of word2vec, the words “man”, “woman”, “king”, and “queen” may each have a respective vector representation. By subtracting the vector representation of “man” from the vector representation of “king”, and then adding the vector representation of “woman”, the result is the vector representation of “queen.”

As another example of the machine learning technique (and more particularly, the NLP technique), GloVe may be used to generate the embeddings. In that regard, GloVe may stand for Global Vectors for word Representation. GloVe is an unsupervised machine learning algorithm for obtaining vector representations for words. GloVe embeddings are a type of word embedding that encode the co-occurrence probability ratio between two words as vector differences. The training of GloVe may be performed on aggregated global word-word co-occurrence statistics from a corpus, and the resulting representations may indicate linear substructures of the word vector space. Compared to word2vec, GloVe may be more suitable in situations involving diverse datasets, and/or when capturing a global context is important.

The document embeddings may also be generated using Bidirectional Encoder Representations from Transformers (BERT) as a machine learning technique. In that regard, BERT models may be built in two phases. The first phase may be a pre-training phase, where the model is trained to understand language. The second phase may be a fine-tuning phase, where the model is further trained on a specific task. BERT may be capable of creating contextualized embeddings that provides good accuracy. In some embodiments, the type of BERT used to generate the embeddings may include Sentence-BERT, which may use a Siamese network-like architecture that provides two sentences as input. These two sentences are then passed to BERT models and a pooling layer to generate their embeddings. The embeddings for the pair of sentences are then used as inputs to calculate the cosine similarity.

The document embeddings may also be generated using a Universal Sentence Encoder. Universal Sentence Encoders may involve a machine learning process to generate fixed-length sentence embeddings. As examples, the Universal Sentence Encoder may encode text into multi-dimensional vectors that can be used for text classification, semantic similarity, clustering and other natural language tasks.

Regardless of the machine learning technique(s) used to generate the document embeddings, once the document embeddings are generated based on the work details captured from the closed work, the document embeddings may be sent to the database component 430 for electronic storage. For example, the document embeddings for each user story may be stored in association with an ID of that user story, and/or the document embeddings for each epic may be stored in association with an ID of that epic. This is done to facilitate the identification and retrieval of the document embeddings in subsequent processes.

In a portion 400B of the process flow 400, the work management tool 410 may detect that more work is being created and/or modified (or has been created and/or modified recently but has not been closed). Upon this detection, the work management tool 410 may communicate with the similarity work checker component 420, for example, by calling the API of the similarity work checker component 420. The similarity work checker component 420 may then perform the preprocessing step and the document embedding generation step discussed above to the captured work data corresponding to recently created and/or modified work. As a result, document embeddings may also be generated from the recently created and/or modified work.

The similarity work checker component 420 may now compare these document embeddings with the document embeddings stored in the database component 430. In some embodiments, a similarity between the different document embeddings may be determined via a Cosine Similarity algorithm. In some embodiments, the similarity between the different document embeddings may be determined via a Euclidean Distance algorithm. One or more similarity scores may be calculated based on the Cosine Similarity algorithm or the Euclidean Distance algorithm. Similarity scores close to 1 (e.g., for Cosine Similarity) may indicate a high degree of similarity between the different document embeddings associated with different epic/user stories. In some embodiments, the similarity score(s) may be compared against a specified threshold, such as 0.65. If two different document embeddings have a similarity score that exceeds the specified threshold, then they may be deemed sufficiently similar, which may indicate that their corresponding epics and/or user stories may be potentially duplicative of one another. In some embodiments, user stories from the same epic may have to meet an even more stringent requirement (e.g., a greater similarity score, such as 0.9 on a scale of 0 to 1) to be considered potentially duplicative. This is because user stories under the same epic may be presumed to contain various similarities, even if they are not actually duplicative of one another. As such, they may be subjected to a more stringent similarity requirement before being deemed potentially duplicative.

Once the list of potentially similar works is determined, the similarity work checker component 420 may communicate it to the work management tool 410, for example, via the API. In some embodiments, the list may be returned to the work management tool 410 as a comment in JIRA™. The similarity scores may also be sent to the work management tool 410 along with the list. The work management tool 410 may then surface the list for user adjudication. As discussed above in association with step 370, the user (which may be the computer programmer or may be a person in a managerial or ownership capacity) may then evaluate the potential duplication and decide to either terminate the epic or user story (if it is deemed to be sufficiently duplicative) or collaborate with other development teams instead (if the degree of similarity warrants further collaboration, rather than termination). In some embodiments, the adjudication may involve personnel from multiple levels of the hierarchy. In addition to the adjudication, the portion 400B of the process flow 400 may also add the document embeddings to the database component 430, so as to update the list of document embeddings stored in the database component 430.

FIG. 5 is a block diagram of a computer system 500 suitable for implementing various methods and devices described herein, for example, the duplicative code detection module 198 (including but not limited to the similarity work checker component 420), the database component 430, the user device 110, the merchant server 140, or the other components of the payment provider server 170. In various implementations, the devices capable of performing the steps may comprise a network communications device (e.g., mobile cellular phone, laptop, personal computer, tablet, etc.), a network computing device (e.g., a network server, a computer processor, an electronic communications interface, etc.), or another suitable device. Accordingly, it should be appreciated that the devices capable of implementing the duplicative code detection module 198 and the various method steps of the process flows 300 and 400 and/or the method 800 discussed below (or the user device 110, the merchant server 140, or the payment provider server 170) may be implemented as the computer system 500 in a manner as follows.

In accordance with various embodiments of the present disclosure, the computer system 500, such as a network server or a mobile communications device, includes a bus component 502 or other communication mechanisms for communicating information, which interconnects subsystems and components, such as a computer processing component 504 (e.g., processor, micro-controller, digital signal processor (DSP), etc.), system memory component 506 (e.g., RAM), static storage component 508 (e.g., ROM), disk drive component 510 (e.g., magnetic or optical), network interface component 512 (e.g., modem or Ethernet card), display component 514 (e.g., cathode ray tube (CRT) or liquid crystal display (LCD)), input component 516 (e.g., keyboard), cursor control component 518 (e.g., mouse or trackball), and image capture component 520 (e.g., analog or digital camera). In one implementation, disk drive component 510 may comprise a database having one or more disk drive components.

In accordance with embodiments of the present disclosure, computer system 500 performs specific operations by the processor 504 executing one or more sequences of one or more instructions contained in system memory component 506. Such instructions may be read into system memory component 506 from another computer readable medium, such as static storage component 508 or disk drive component 510. In other embodiments, hard-wired circuitry may be used in place of (or in combination with) software instructions to implement the present disclosure. In some embodiments, the various components of the duplicative code detection module 198 may be in the form of software instructions that can be executed by the processor 504 to automatically perform context-appropriate tasks on behalf of a user.

Logic may be encoded in a computer readable medium, which may refer to any medium that participates in providing instructions to the processor 504 for execution. Such a medium may take many forms, including but not limited to, non-volatile media and volatile media. In one embodiment, the computer readable medium is non-transitory. In various implementations, non-volatile media includes optical or magnetic disks, such as disk drive component 510, and volatile media includes dynamic memory, such as system memory component 506. In one aspect, data and information related to execution instructions may be transmitted to computer system 500 via a transmission media, such as in the form of acoustic or light waves, including those generated during radio wave and infrared data communications. In various implementations, transmission media may include coaxial cables, copper wire, and fiber optics, including wires that comprise bus 502.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. These computer readable media may also be used to store the programming code for the duplicative code detection module 198 discussed above.

In various embodiments of the present disclosure, execution of instruction sequences to practice the present disclosure may be performed by computer system 500. In various other embodiments of the present disclosure, a plurality of computer systems 500 coupled by communication link 530 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 530 and communication interface 512. Received program code may be executed by computer processor 504 as received and/or stored in disk drive component 510 or some other non-volatile storage component for execution. The communication link 530 and/or the communication interface 512 may be used to conduct electronic communications between the duplicative code detection module 198 and external devices, for example with the user device 110, with the merchant server 140, or with the payment provider server 170, depending on exactly where the duplicative code detection module 198 is implemented.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein. It is understood that at least a portion of the duplicative code detection module 198 may be implemented as such software code.

As discussed above, machine learning may be used to perform various aspects of the present disclosure, such as to the generate the document embeddings. In some embodiments, the machine learning may be performed at least in part via an artificial neural network, which may be used to implement at least portions of the duplicative code detection module 198 of FIG. 1. In that regard, FIG. 6 illustrates an example artificial neural network 600 as one type of machine learning model. As shown, the artificial neural network 600 includes three layers—an input layer 602, a hidden layer 604, and an output layer 606. Each of the layers 602, 604, and 606 may include one or more nodes. For example, the input layer 602 includes nodes 608-614, the hidden layer 604 includes nodes 616-618, and the output layer 606 includes a node 622. In this example, each node in a layer is connected to every node in an adjacent layer. For example, the node 608 in the input layer 602 is connected to both of the nodes 616-618 in the hidden layer 604. Similarly, the node 616 in the hidden layer is connected to all of the nodes 608-614 in the input layer 602 and the node 622 in the output layer 606. Although only one hidden layer is shown for the artificial neural network 600, it has been contemplated that the artificial neural network 600 used to implement at least a part of the duplicative code detection module 198, and the duplicative code detection module 198 may include as many hidden layers as necessary.

In this example, the artificial neural network 600 receives a set of input values and produces an output value. Each node in the input layer 602 may correspond to a distinct input value. For example, when the artificial neural network 600 is used to implement the duplicative code detection modules 198, each node in the input layer 602 may correspond to a distinct parameter of an event.

In some embodiments, each of the nodes 616-618 in the hidden layer 604 generates a representation, which may include a mathematical computation (or algorithm) that produces a value based on the input values received from the nodes 608-614. The mathematical computation may include assigning different weights to each of the data values received from the nodes 608-614. The nodes 616 and 618 may include different algorithms and/or different weights assigned to the data variables from the nodes 608-614 such that each of the nodes 616-618 may produce a different value based on the same input values received from the nodes 608-614. In some embodiments, the weights that are initially assigned to the features (or input values) for each of the nodes 616-618 may be randomly generated (e.g., using a computer randomizer). The values generated by the nodes 616 and 618 may be used by the node 622 in the output layer 606 to produce an output value for the artificial neural network 600. The output value produced by the artificial neural network 600 may indicate a likelihood of an event.

The artificial neural network 600 may be trained by using training data. For example, the training data herein may include the computer software code of previous epics or user stories that have been deemed duplicative according to the aspects of the present disclosure. By providing training data to the artificial neural network 600, the nodes 616-618 in the hidden layer 604 may be trained (adjusted) such that an optimal output (e.g., determining a value for a threshold) is produced in the output layer 606 based on the training data. By continuously providing different sets of training data, and penalizing the artificial neural network 600 when the output of the artificial neural network 600 is incorrect (e.g., when the predicted classification of an event is inconsistent with the actual classification of the event, etc.), the artificial neural network 600 (and specifically, the representations of the nodes in the hidden layer 604) may be trained (adjusted) to improve its performance in data classification. Adjusting the artificial neural network 600 may include adjusting the weights associated with each node in the hidden layer 604.

Although the above discussions pertain to an artificial neural network as an example of machine learning, it is understood that other types of machine learning methods may also be suitable to implement the various aspects of the present disclosure. For example, gradient boosting may be used to implement the machine learning, which is a machine learning technique for regression and classification problems. Gradient boosting generates a prediction model, which could be in the form of decision trees. As another example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

FIG. 7 illustrates an example cloud-based computing architecture 700, which may also be used to implement various aspects of the present disclosure. The cloud-based computing architecture 700 includes a mobile device 704 (e.g., the user device 110 of FIG. 1) and a computer 702 (e.g., the merchant server 140 or the payment provider server 170), both connected to a computer network 706 (e.g., the Internet or an intranet). In one example, a consumer has the mobile device 704 that is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing may be performed by the cloud-based resources 708. However, other divisions of responsibility are also possible in various embodiments. In some embodiments, using this cloud architecture, the duplicative code detection module 198 may reside on the merchant server 140 or the payment provider server 170, but its functionalities can be accessed or utilized by the mobile device 704, or vice versa.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702. The system and method for performing the machine learning process as discussed above may be implemented at least in part based on the cloud-based computing architecture 700.

It is understood that the various components of cloud-based computing architecture 700 are shown as examples only. For instance, a given user may access the cloud-based resources 708 by a number of devices, not all of the devices being mobile devices. Similarly, a merchant or another user may access the cloud-based resources 708 from any number of suitable mobile or non-mobile devices. Furthermore, the cloud-based resources 708 may accommodate many merchants and users in various embodiments.

FIG. 8 is a flowchart illustrating a method 800 for detecting potentially duplicative computer software code according to various aspects of the present disclosure. In some embodiments, the various steps of the method 800, which are described in greater detail below, may be performed by a single system. The single system may include one or more computer processors and a non-transitory computer-readable medium having stored thereon instructions that are executable by the one or more processors to cause the system to perform the steps of the method 800. In some embodiments, the system may include a computer of an entity, such as a payment provider, an operator of an electronic transaction platform, an online merchant, a cybersecurity platform, a healthcare organization, or a business analyst, etc. In some embodiments, at least some of the steps of the method 800 may be performed by the duplicative code detection module 198 discussed above.

The method 800 includes a step 810 to determine computer software code corresponding to one or more particular levels of hierarchy of a work structure of an entity has been created or modified. In some embodiments, the work structure comprises an initiative as a first level of the hierarchy, a program as a second level of the hierarchy below the first level of the hierarchy, a project name as a third level of the hierarchy below the second level of the hierarchy, an epic as a fourth level of the hierarchy below the third level of the hierarchy, and a user story as a fifth level of the hierarchy below the fourth level of the hierarchy, such as shown in the work structure 200 of FIG. 2. In some embodiments, the one or more particular levels of hierarchy correspond to at least one of the epic or the user story, which may be the levels 250 and 260 of the hierarchy of FIG. 2, respectively. In some embodiments, the determination of step 810 is made as a part of the portion 400B of the process flow 400 of FIG. 4, where the work management tool 410 notifies the similarity work checker component 420 of the creation and/or modification of the computer software code.

The method 800 includes a step 820 to access one or more work data fields associated with the computer software code. In some embodiments, the one or more work data fields comprise a title of the epic or the user story, a summary of the epic or the user story, a description of the epic or the user story, an outcome of the epic or the user story, or a metric or a performance indicator of the epic or the user story. In some embodiments, step 820 is performed as a part of the portion 400B of the process flow 400 of FIG. 4, where the similarity work checker component 420 accesses the various work data fields.

The method 800 includes a step 830 to generate a first document embedding based on the one or more work data fields. The first document embedding comprises multi-dimensional vectors that represent a semantic content of the first document embedding. In some embodiments, the first document embedding is generated using one or more techniques that comprise: Word2Vec, GloVe, Sentence-BERT, or Universal Sentence Encoder. In some embodiments, step 830 is also performed as a part of the portion 400B of the process flow 400 of FIG. 4, where the similarity work checker component 420 uses the various machine learning techniques to generate the first document embedding.

The method 800 includes a step 840 to perform a similarity check between the first document embedding and one or more other document embeddings. In some embodiments, the similarity check is performed using a technique based on Cosine Similarity or based on Euclidean Distance. In some embodiments, step 840 is also performed as a part of the portion 400B of the process flow 400 of FIG. 4, where the similarity work checker component 420 accesses the one or more other document embeddings stored in the database component 430 and compares them with the first document embedding.

The method 800 includes a step 850 to perform an action based on a determination that the similarity check indicates that a similarity between the first document embedding and the one or more other document embeddings meets a specified threshold. In some embodiments, the action comprises automatically notifying a member of the entity that the computer software code may be duplicative of computer software code associated with the one or more other document embeddings. In some embodiments, a similarity score is generated as a result of the similarity check, and the specified threshold corresponds to a specified similarity score. In some embodiments, the action is performed based on the determination that the similarity check indicates that the similarity between the first document embedding and the one or more other document embeddings meets a first specified threshold when the first document embedding and the one or more other document embeddings are generated from a same user story or a same epic. In some embodiments, the action is performed based on the determination that the similarity check indicates that the similarity between the first document embedding and the one or more other document embeddings meets a second specified threshold when the first document embedding and the one or more other document embeddings are generated from different epics, wherein the first specified threshold is more stringent than the second specified threshold.

It is understood that additional method steps may be performed before, during, or after the steps 810-850 discussed above. For example, the method 800 may include a step of storing the first document embedding in an electronic database. The one or more other document embeddings are retrieved from the electronic database before the similarity check is performed. As another example, the method 800 may include a preprocessing step that is before the first document embedding is generated. According to the preprocessing step, the one or more work data fields may be tokenized, lowercased, stemmed, lemmatized, have their stop words removed, or have a key phrase extraction performed. The first document embedding is generated based on the one or more work data fields after the one or more work data fields have been preprocessed.

Based on the above discussions, systems and methods described in the present disclosure offer several significant advantages over conventional methods and systems. It is understood, however, that not all advantages are necessarily discussed in detail herein, different embodiments may offer different advantages, and that no particular advantage is required for all embodiments. One advantage is improved functionality of a computer. For example, the present disclosure uses machine learning (e.g., NLP) to detect similarities between the computer software code of different works, which may be used to identify duplicative works. The duplicative work may then be terminated, or additional collaboration may be performed to integrate the otherwise potentially duplicative works into a better overall product.

By doing so, the present disclosure reduces the waste of electronic resources associated with generating the work. For example, creating epics and/or user stories necessarily involve not just human resources, but also computer processing power, which would be wasted if the epics and/or user stories end up being duplicative of other existing epics and/or user stories. The electronic storage of the duplicative epics and/or user stories also leads to waste of electronic storage, which could be freed up to store other non-duplicative electronic files. The electronic communication of the duplicative epics and/or user stories may also result in a waste of electronic communication bandwidth. Here, by identifying and eliminating the duplicative works, the present disclosure can reduce these forms of electronic waste, and as such, improves the functionality of a computer.

The inventive ideas of the present disclosure are also integrated into a practical application, for example into the duplicative code detection module 198 discussed above. As discussed above, many organizations may have different teams of software developers that end up working on projects with overlapping scope, especially as the size of the organization increases. If the different of teams of developers are not aware of what projects other teams of developers are working on, their development efforts may lead to waste, as discussed above. The present application implements the duplicative code detection module 198 as a practical application that can automatically detect when an epic or a user story is potentially duplicative of other epics or user stories, without any effort (e.g., manual intervention) by the software developer teams. In addition, the appropriate personnel is also automatically notified of the potential duplication of the software code, who may then take necessary actions to address it (e.g., by terminating the work project that is deemed to be duplicative). Therefore, any organization that performs internal software development may implement the various aspects of the present disclosure as a practical application to reduce waste and cost and to increase operational efficiency.

It should be appreciated that like reference numerals are used to identify like elements illustrated in one or more of the figures, wherein these labeled figures are for purposes of illustrating embodiments of the present disclosure and not for purposes of limiting the same.

One aspect of the present disclosure involves a method that includes the following steps: determining computer software code corresponding to one or more particular levels of hierarchy of a work structure of an entity has been created or modified; accessing one or more work data fields associated with the computer software code; generating a first document embedding based on the one or more work data fields, wherein the first document embedding comprises multi-dimensional vectors that represent a semantic content of the first document embedding; performing a similarity check between the first document embedding and one or more other document embeddings; and performing an action based on a determination that the similarity check indicates that a similarity between the first document embedding and the one or more other document embeddings meets a specified threshold.

Another aspect of the present disclosure involves a system that includes a non-transitory memory and one or more hardware processors coupled to the non-transitory memory and configured to read instructions from the non-transitory memory to cause the system to perform operations comprising: extracting first data from computer software code corresponding to one or more particular levels of hierarchy of a work structure of an organization; generating, based on the first data, a plurality of first vector embeddings; accessing a plurality of second vector embeddings stored in an electronic database, wherein the plurality of second vector embeddings were previously derived from existing computer software code; evaluating a similarity between the plurality of first vector embeddings with the plurality of second vector embeddings, wherein a similarity score is calculated as a part of the evaluating; comparing the similarity score against a specified threshold score; and automatically notifying, based on the similarity score meeting the specified threshold score, a member of the organization that the computer software code should be reviewed for duplication with respect to the existing computer software code.

Yet another aspect of the present disclosure involves a non-transitory machine-readable medium having stored thereon machine-readable instructions executable to cause a machine to perform operations comprising: receiving, from a work management tool, a notification that computer software code corresponding to a first epic or a first user story has been created or modified, wherein the first epic and the first user story are located at different hierarchical levels of a work structure of an organization; preprocessing textual data associated with the first epic or the first user story at least in part by tokenizing the textual data, lowercasing the textual data, removing stop words from the textual data, stemming the textual data, lemmatizing the textual data, or performing a key phrase extraction on the textual data; generating, at least in part using a technique that comprises Word2Vec, GloVe, Sentence-BERT, or Universal Sentence Encoder, a first document embedding based on the preprocessed textual data; accessing one or more second document embeddings that were stored in an electronic database, wherein the one or more second document embeddings were generated based on one or more second epics or one or more second user stories associated with the organization; determining a degree of similarity between the first document embedding and the one or more second document embeddings; and performing an action based on the determining indicating that the degree of similarity between the first document embedding and the one or more second document embeddings meets a specified threshold.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
determining computer software code corresponding to one or more particular levels of hierarchy of a work structure of an entity has been created or modified;
accessing one or more work data fields associated with the computer software code;
generating a first document embedding based on the one or more work data fields, wherein the first document embedding comprises multi-dimensional vectors that represent a semantic content of the first document embedding;
performing a similarity check between the first document embedding and one or more other document embeddings; and
performing an action based on a determination that the similarity check indicates that a similarity between the first document embedding and the one or more other document embeddings meets a specified threshold.

2. The method of claim 1, wherein the action comprises automatically notifying a member of the entity that the computer software code may be duplicative of computer software code associated with the one or more other document embeddings.

3. The method of claim 1, wherein:
the work structure comprises an initiative as a first level of the hierarchy, a program as a second level of the hierarchy below the first level of the hierarchy, a project name as a third level of the hierarchy below the second level of the hierarchy, an epic as a fourth level of the hierarchy below the third level of the hierarchy, and a user story as a fifth level of the hierarchy below the fourth level of the hierarchy; and
the one or more particular levels of hierarchy correspond to at least one of the epic or the user story.

4. The method of claim 3, wherein the one or more work data fields comprise a title of the epic or the user story, a summary of the epic or the user story, a description of the epic or the user story, an outcome of the epic or the user story, or a metric or a performance indicator of the epic or the user story.

5. The method of claim 1, wherein:
the action is performed based on the determination that the similarity check indicates that the similarity between the first document embedding and the one or more other document embeddings meets a first specified threshold when the first document embedding and the one or more other document embeddings are generated from a same user story or a same epic; or
the action is performed based on the determination that the similarity check indicates that the similarity between the first document embedding and the one or more other document embeddings meets a second specified threshold when the first document embedding and the one or more other document embeddings are generated from different epics, wherein the first specified threshold is more stringent than the second specified threshold.

6. The method of claim 1, further comprising: storing the first document embedding in an electronic database, wherein the one or more other document embeddings are retrieved from the electronic database before the similarity check is performed.

7. The method of claim 1, further comprising: before the first document embedding is generated, preprocessing the one or more work data fields at least in part by tokenizing the one or more work data fields, lowercasing the one or more work data fields, removing stop words of the one or more work data fields, stemming the one or more work data fields, lemmatizing the one or more work data fields, or performing a key phrase extraction on the one or more work data fields, wherein the first document embedding is generated based on the one or more work data fields after the one or more work data fields have been preprocessed.

8. The method of claim 1, wherein the first document embedding is generated using one or more techniques that comprise: Word2Vec, GloVe, Sentence-BERT, or Universal Sentence Encoder.

9. The method of claim 1, wherein the similarity check is performed using a technique based on Cosine Similarity or based on Euclidean Distance.

10. The method of claim 1, wherein:
a similarity score is generated as a result of the similarity check; and
the specified threshold corresponds to a specified similarity score.

11. A system comprising:
a processor; and
a non-transitory computer-readable medium having stored thereon instructions that are executable by the processor to cause the system to perform operations comprising:
extracting first data from computer software code corresponding to one or more particular levels of hierarchy of a work structure of an organization;
generating, based on the first data, a plurality of first vector embeddings;
accessing a plurality of second vector embeddings stored in an electronic database, wherein the plurality of second vector embeddings were previously derived from existing computer software code;
evaluating a similarity between the plurality of first vector embeddings with the plurality of second vector embeddings, wherein a similarity score is calculated as a part of the evaluating;
comparing the similarity score against a specified threshold score; and
automatically transmitting a notification, based on the similarity score meeting the specified threshold score, to a member of the organization, wherein the notification comprises an indication that the computer software code may be duplicative to the existing computer software code.

12. The system of claim 11, wherein:
the work structure comprises a first level of the hierarchy that includes one or more initiatives, a second level of the hierarchy that includes one or more programs, a third level of the hierarchy that includes one or more projects, a fourth level of the hierarchy that includes one or more epics, and a fifth level of the hierarchy that includes one or more user stories; and
the first data is extracted from a first epic of the one or more epics or a first user story of the one or more user stories.

13. The system of claim 12, wherein:
the first data is extracted from a title of the first epic or the first user story, a summary of the first epic or the first user story, a description of the first epic or the first user story, an outcome of the first epic or the first user story, or a metric or a performance indicator of the first epic or the first user story.

14. The system of claim 12, wherein the operations further comprise, before the accessing:
extracting second data from computer software code corresponding to one or more second epics of the one or more epics or one or more second user stories of the one or more user stories;
generating, based on the second data, the plurality of second vector embeddings; and
storing the plurality of second vector embeddings in the electronic database.

15. The system of claim 11, wherein the operations further comprise: before the generating, performing one or more of the following processes to the first data: a tokenization process, a lowercasing process, a stop-words removal process, a stemming process, or a lemmatization process.

16. The system of claim 11, wherein the plurality of first vector embeddings are generated at least in part based on one or more techniques that comprise: Word2Vec, GloVe, Sentence-BERT, or Universal Sentence Encoder.

17. The system of claim 11, wherein the evaluating is performed at least in part based on a Cosine Similarity or Euclidean Distance.

18. A non-transitory machine-readable medium having stored thereon machine-readable instructions executable to cause a machine to perform operations comprising:
receiving, from a work management tool, a notification that computer software code corresponding to a first epic or a first user story has been created or modified, wherein the first epic and the first user story are located at different hierarchical levels of a work structure of an organization;
preprocessing textual data associated with the first epic or the first user story at least in part by tokenizing the textual data, lowercasing the textual data, removing stop words from the textual data, stemming the textual data, lemmatizing the textual data, or performing a key phrase extraction on the textual data;
generating, at least in part using a technique that comprises Word2Vec, GloVe, Sentence-BERT, or Universal Sentence Encoder, a first document embedding based on the preprocessed textual data;
accessing one or more second document embeddings that were stored in an electronic database, wherein the one or more second document embeddings were generated based on one or more second epics or one or more second user stories associated with the organization;
determining a degree of similarity between the first document embedding and the one or more second document embeddings; and
performing an action based on the determining indicating that the degree of similarity between the first document embedding and the one or more second document embeddings meets a specified threshold.

19. The non-transitory machine-readable medium of claim 18, wherein the action comprises sending an electronic notification to a member of the organization that the first epic or the first user story should be checked for duplicacy with the one or more second epics or the one or more second user stories.

20. The non-transitory machine-readable medium of claim 18, wherein the degree of similarity is determined at least in part using a technique based on Cosine Similarity or based on Euclidean Distance.
